(19) United States
(12) Patent Application Publication
(10) Pub. No.: US 2005/0160298 A1
(43) Pub. Date: Jul. 21, 2005

(54) Nonredirected authentication

(75) Inventor: James D. Reno, Scotts Valley, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Arcot Systems, Inc., Sunnyvale, CA (US)

(21) Appl. No.: 11/016,248

(22) Filed: Dec. 17, 2004

Related U.S. Application Data
(60) Provisional application No. 60/537,978, filed on Jan. 20, 2004.

(51) Int. Cl. H04L 9/00

(52) U.S. Cl. 713/202

(57) ABSTRACT

A method for authenticating a user at a service requester is provided. A request for a secure transaction is received from the user at the service requester. The user then generates a token using a token generator. The token is generated using secure information associated with the user. The token is received at the service requester and the service requester can then provide the token to a service provider for authentication. The service provider is capable of authenticating the token and generating a result for the authentication. The result is then sent to the service requester, which then processes the transaction based on the authentication result. Accordingly, the user may be authenticated by the service provider without the secure information associated with the user being accessible to the service requester and the service provider does not need to generate the token received from the user.

### CROSS-REFERENCES TO RELATED APPLICATIONS

This application claims priority from co-pending U.S. Provisional Patent Application No. 60/537,978 filed Jan. 20, 2004 entitled NONREDIRECTED AUTHENTICATION which is hereby incorporated by reference, as if set forth in full in this document, for all purposes.

### BACKGROUND OF THE INVENTION

The present invention generally relates to authentication and more specifically to systems and apparatus for authenticating users without redirection.

Some transactions require that a party be authenticated prior to completing the transaction. For example, on-line transactions may involve an online browser-based system where users interact with a website to complete a transaction. An on-line shopping transaction includes a series of interactions represented by successive web pages and inputs that together result in the purchase of goods and services. Before the sale of goods and services can be realized, a user purchasing the goods or services may need to be authenticated. The transactions also do not need to involve sales of goods and/or services and do not need to be financial. For example, a transaction might involve a user signing up for a newsletter or completing an on-line survey.

Typically, the user is redirected to another website for a subset of the transaction activities. The second site may be referred to as a service provider and the initial site as the service requester. The user and the service requester interact to complete the transaction. In one such system, a 3-D secure protocol used by Visa (verified by Visa) and MasterCard (MasterCard SecureCode), a user, shopping at a merchant site, is sent to the service provider provided by the card issuer, which authenticates the user and returns a result to the service requester. This redirection may take place using the main browser or may use a newly created “pop-up” window.

In the above example, the user is redirected to the service provider. Redirection may be at the request of the user or the service requester may determine that the user should be redirected to the service provider. The user then directly interacts with the service provider in order to authenticate the user. The service provider then sends the authentication result to the service requester.

The purpose of the redirection is to establish communication between the user and the service provider site such that the service provider can provide the specified service without the service requester site having knowledge or visibility into this communication. The user may authenticate him/herself to the service provider site using a password or any other methods. The service requester site is not involved in this communication and is thus not privy to any authentication information or to the authentication process at all. The service requester site merely refers the user and receives the authentication result that indicates whether the authentication has succeeded or failed. The token that is generated by the service provider may be sent to the service requester and that token is used in processing the transaction. The token provided by the service provider may serve to provide a business relationship or characteristic of the transaction that would not have occurred without the service request/reply process. For example, in the 3-D secure system, the token asserts that the service provider authenticated the user and accepts liability for the transaction.

The redirection ensures that the private communication between the user and the service provider is isolated from the initial communication between the user and the service requester. Thus, privacy and security is provided, allowing the two processes to be independently implemented. However, many problems with the process exist. For example, a web browser being used by a user may not have the capabilities to support the redirection. For example, a browser window may not be able to use “pop-up” windows. Also, users may be confused by redirection and close a window or may not know what to do with the pop-up window.

In some cases, a two party system is used where a user can generate a token him/herself and send that token to the service requester. In this case, the user may enter a password that the service requester then authenticates the user. This does not have the advantage of an authentication process that is performed by a third party. Thus, the authentication that the service requester provides does not serve to shield the service requester from any liability that may result from processing the transaction.

### BRIEF SUMMARY OF THE INVENTION

The present invention generally relates to authentication without redirection. In one embodiment, a method for authenticating a user at a service requester is provided. A request for a secure transaction is received from the user at the service requester. The user then generates a token using a token generator. The token is generated using secure information associated with the user. The token is received at the service requester and the service requester can then provide the token to a service provider for authentication. The service provider is capable of authenticating the token and generating a result for the authentication. The result is then sent to the service requester, which then processes the transaction based on the authentication result. Accordingly, the user may be authenticated by the service provider without the secure information associated with the user being accessible to the service requester and the service provider does not need to generate the token received from the user.

In one embodiment, a method for performing a three-party transaction with a user, service requester, and an authenticator is provided. The method comprises: receiving a request for a secure transaction at the service requester; receiving a token from the user, the token being generated by the user using secure information associated with the user; providing the secure token to the authenticator, the authenticator capable of authenticating the token, wherein the secure information is not accessible to the service requester.

In another embodiment, a method of authentication in a three-party transaction without using redirection is provided. The method comprises: receiving a request for authentication at a first entity; requesting a token from a user; receiving the token from the user, wherein the token is considered secure by the user and the user is not redirected to a second entity; and authenticating the received token with the second entity.

In another embodiment, a system for authenticating a user is provided. The system comprises: a token generator configured to generate tokens; a service requester configured to process a transaction for a user; a service provider configured to authenticate tokens generated by the token generator, wherein a user generates a unique token generated for the transaction using the token generator and provides the unique token to the service requester, wherein the service requester cooperates with the service provider to authenticate the unique token.

A further understanding of the nature and the advantages of the inventions disclosed herein may be realized by reference of the remaining portions of the specification.

### BRIEF DESCRIPTION OF THE DRAWINGS

FIG. 1 depicts a system for authenticating a user according to one embodiment of the present invention.

FIG. 2 depicts a simplified flowchart of a method for authenticating a user without redirection according to one embodiment of the present invention.

FIG. 3 depicts a simplified flowchart of a method for generating a token according to one embodiment of the present invention.

FIG. 4 depicts a simplified flowchart of a method for generating secure information according to one embodiment of the present invention.

### DETAILED DESCRIPTION OF THE INVENTION

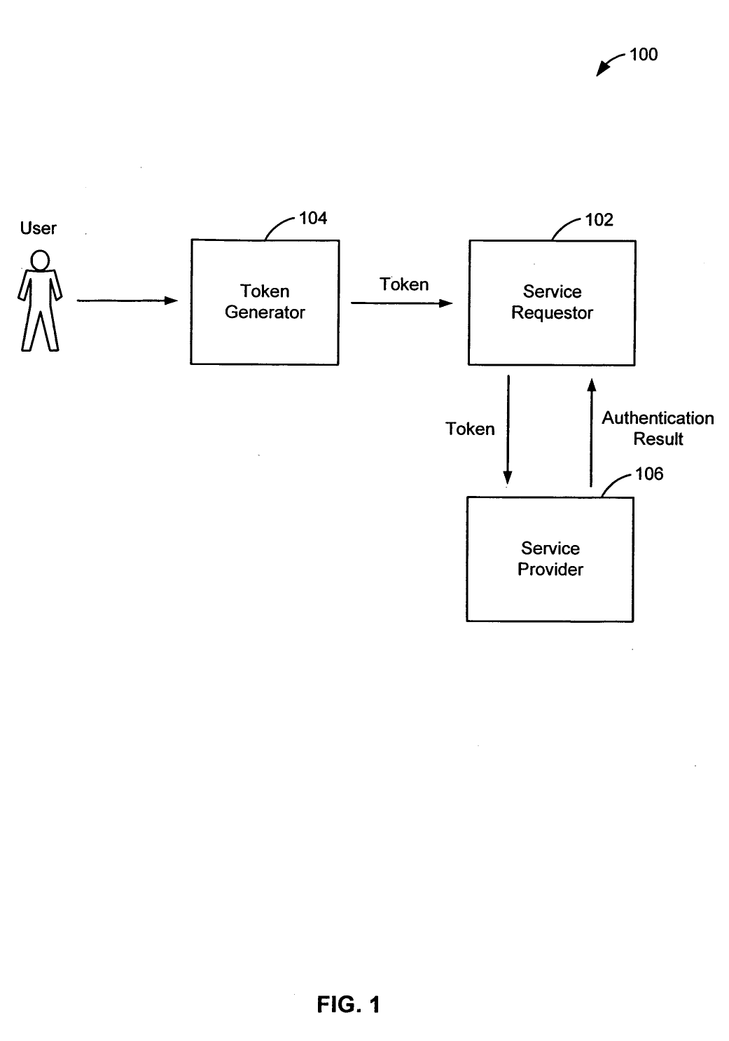

FIG. 1 depicts a system 100 for authenticating a user according to one embodiment of the present invention. System 100 includes a service requester 102, a token generator 104, and a service provider 106.

In one embodiment, a user desires to have a transaction processed. A transaction may be some sequence of related activities that, taken together and upon completion, provide some outcome (sometimes beneficial) for the user and/or the service requester 102. A user may be any entity. For example, a user may be a person conducting the transaction, an application, a corporation, or any other entity capable of entering into a transaction. It will be understood that when a user is described, the user may be any entity and not just a person.

Service requester 102 may be any entity configured to process a transaction for the user. For example, a service requester 102 may be a merchant with an on-line website. Service requester 102 may also be an entity other than an on-line website. For example, service requester 102 may include a brick and mortar store with a checkout counter. The checkout counter may be configured to process transactions for users. Also, a home banking or mortgage application, a kiosk, government agency or health care provider, voting machine or any other entity that may need to authenticate a user may be service requesters. Also, service requester 102 may process transactions of a nonfinancial type, such as signing up users for a newsletter, enabling users to complete an online survey, etc.

Service provider 106 is any entity that can authenticate a token and provide an authentication result. For example, service provider 106 may be an issuer of a credit card, any financial institution, government agency, etc. Service provider 106 is configured to generate the secure information and provide it to the user.

Token generator 104 is configured to generate a token to be sent to service requester 102. Token generator 104 may include software, hardware, or any combination thereof as configured to generate a token. In one embodiment, a token is uniquely generated for each transaction. For example, token generator 104 may include a computer, an application on a computer or other computing device (personal digital assistant (PDA)), etc.

Token generator 104 generates a token using secure information. The secure information is associated with the user. In one embodiment, service provider 106 generates the secure information and sends the secure information to the user. The secure information may then be loaded onto token generator 104 or somehow installed on token generator 104. Also, service provider 106 may provide token generator 104 to the user.

The token may be generated in any number of ways. For example, the secure information may include cryptographic keys stored locally or on removable media. Using software on token generator 104, the keys may be used to generate a token. The keys may be stored using currently available browser technology or protected as part of an identifier using cryptographic camouflage, or any other method.

Token generator 104 may be a removable device such as a USB device that includes the secure information and software that can generate a token. Token generator 104 may also be a chip card with a reader. A user may insert the chip card into the reader. The reader may be attached to a computing device, such as a computer, or may be stand-alone. In either case, information may be received from the user and the reader communicates with the chip card, which generates a token. The reader then displays the token. Also, token generator 104 may be a device that generates a pseudo-random number that is synchronized with service provider 106 such that service provider 106 can determine the generated value based on a condition, such as time or a sequence of events.

Token generator 104 generates the token by using the secure information accessible to token generator 104. The secure information is provided by service provider 106, but service provider 106 does not participate during the generation of the token during the transaction. However, service provider 106 is capable of authenticating the token generated for the transaction. Service provider 106 can authenticate the token because it has some knowledge of the secure information that allows it to authenticate a token generated using the secure information and token generator 104.

The token may be in any form. In one embodiment, the token is in a form that may be easily entered by a user. For example, the user may type in or key in the token. Accordingly, the size and composition may lend itself to easy keying by a user. In one embodiment, the content and construction of the token does not have to be known to the user or to service requester 102. However, it should have meaning to service provider 106. For example, service provider 106 should be able to authenticate the token. For example, the service provider is the one who gave the token generator to the user. If the token generator contains a secret key and a random number generator, service provider 106 may know the secret key. When the user triggers the token generator 104, it generates a new random number and encrypts it with the key. The token is a combination of the random number and the encrypted value. Since service provider 106 may know the key, it can verify the encrypted value is correct. A person skilled in the art will appreciate the methods of authentication of a token. Authenticating the token for service provider 106 may assert a business relationship or transaction characteristic to service requester 102 if the token is authenticated. For example, when service provider 106 authenticates a token, and thus the user, service provider 106 may accept fraud liability. Service requester 102 may later present the token to service provider 106 and receive fraud protection.

The token may be transmitted with the authentication result or may be stored by a service provider 106 for processing for later use if the transaction is later disputed. For example, if a transaction is disputed, the token for the transaction can be presented to service provider 106. Service provider 106 can then accept liability for the transaction based on records that it authenticated the token.

In one embodiment, because a token may be used in securing a transaction, a token is created in a way that cannot be duplicated by the user or service requester 102. Thus, service provider 106 can consider the token secure. Thus, in one embodiment, a token is generated on a per-transaction basis. Accordingly, a unique token is created for each transaction. If the token is generated cryptographically, the keys are issued by service provider 106 (or by an agent) and protected with mechanisms that ensure the integrity of the keys.

The nature of the keys, how they are sent to the user, and the mechanism for creating the token is forwarded to the user may be embodied in token generator 104. For example, the keys may be downloaded to token generator 104 or token generator 104 may be sent to the user. For example, the cryptographic keys may be sent to a user. The software may be shipped on media, downloaded, and emailed, picked up in person, etc. Additionally, hardware may be similarly delivered to a user by any available methods. The cryptographic keys, if required, may be inherent to other components of the hardware, software, or any combination thereof. For example, the keys may be present on a chip card found in hardware shipped to the user. Also, the keys may be found in software or generated by a user.

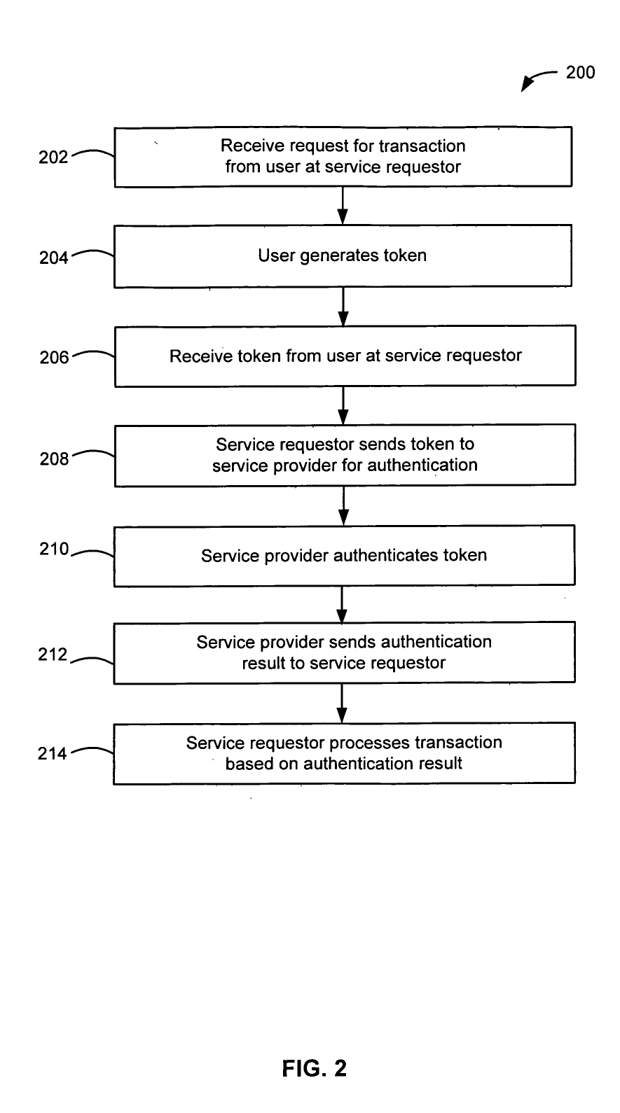

FIG. 2 depicts a simplified flowchart 200 of a method for authenticating a user without redirection according to one embodiment of the present invention. In step 202, service requester 102 receives a request for a transaction from a user. In one embodiment, the request may be received through a website operated by a service requester 102. It will be recognized that requests may be received by other methods.

In step 204, the user generates a token using token generator 104. The token may be generated as described by any of the methods described above. For example, a token is generated using secure information that is associated with the user.

In step 206, the token is received from the user at service requester 102. In one embodiment, the user may key in or enter in the token and send it to service requester 102. It will be recognized that the token may be received by other methods. For example, the user may verbally speak the token to service requester 102.

In step 208, service requester 102 sends the token to service provider 106 for authentication. The token may be sent by any communication methods. For example, an on-line website may be configured to send the token to service provider 106.

In step 210, service provider 106 authenticates the token. Service provider 106 may be the entity that issued the secure information to the user. In another embodiment, an agent of service provider 106 may have issued the secure information. In either case, service provider 106 is configured to able to authenticate the token. By authenticating the token, service provider 106 may accept liability for the authentication. For example, if fraud occurs in the transaction, service requester 102 may request fraud protection from service provider 106. Accordingly, service provider 106 should be able to authenticate the token in a manner in which fraud liability may be asserted.

In step 212, service provider 106 sends an authentication result to service requester 102. The result may indicate that the authentication succeeded or failed. Additionally, the token may be sent with the authentication result. Service requester 102 may then store the token with a transaction record for future reference. For example, when fraud results from the transaction, the token may be used to obtain fraud protection from service requester 106. In another embodiment, service provider 106 may store the token and a record of the transaction for later use if the transaction is later disputed.

Service requester 102 then processes a transaction based on the authentication result. For example, service requester 102 may approve the transaction with the user if the authentication is approved. Additionally, service requester 102 may deny the transaction if the authentication is not successful.

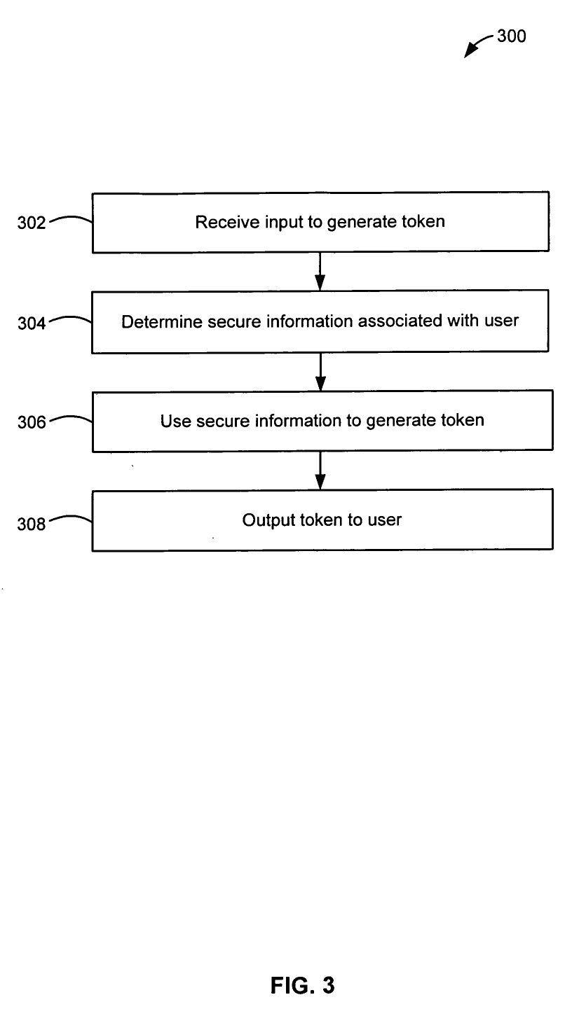

FIG. 3 depicts a simplified flowchart 300 of a method for generating a token according to one embodiment of the present invention. In step 302, token generator 104 receives an input to generate a token. The input may be in the form of a selection from a user to generate a token. For example, token generator 104 may be a standalone device in which a user may select an input to generate a token. Additionally, the user may select an input found on a website that will generate a token. The user may need to enter into token generator 104 some information known only to the user and token generator 104, such as a pin.

In step 304, secure information associated with the user is determined. The secure information is information that is not accessible to the service requester 102. For example, the secure information may be stored in the standalone device. Also, the secure information may be stored and accessible to software and/or hardware that are invoked by a user selecting a “generate token” button on a website.

In step 306, the secure information is used to generate the token. The token may be generated by any methods described above. For example, cryptographic keys may be used as secure information to generate a token. Preferably, the token generated is easily keyed in for a user. Thus, the size and composition may lend itself to easy keying in.

In step 308, the token is outputted to a user. For example, the token may be displayed on a screen of a standalone device or a browser on a computer screen. The token may then be sent to service requester 102.

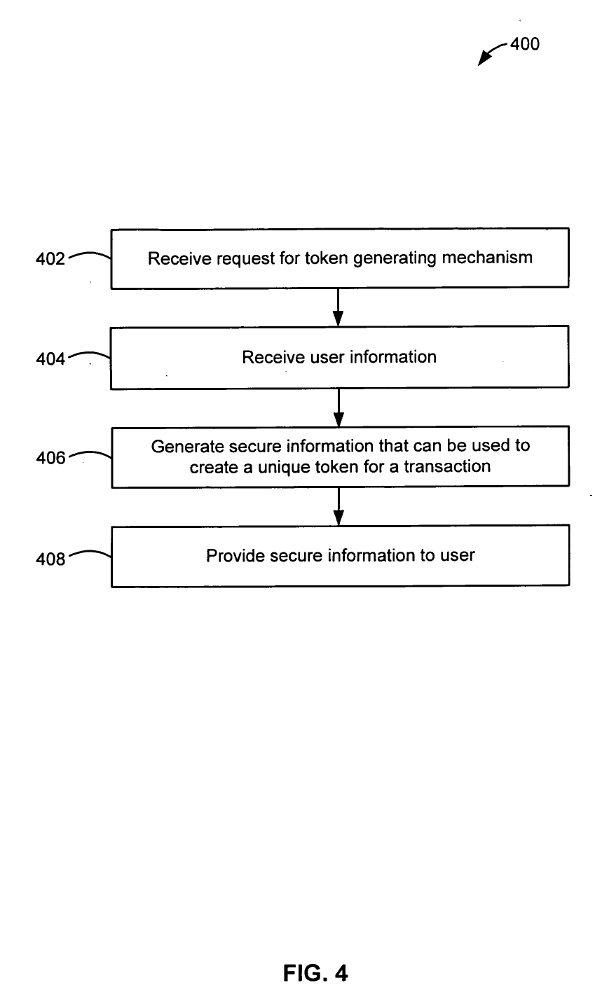

FIG. 4 depicts a simplified flowchart 400 of a method for generating secure information according to one embodiment of the present invention. In step 402, service provider 106 or an agent of service provider 106 receives a request for a token-generating mechanism. The token-generating mechanism may be cryptographic keys, a physical token-generating device, software that can generate a token, etc.

In step 404, user information is received. The user information may be information that can uniquely identify the user. For example, a user name, Social Security number, address, account number, etc. may be received.

In step 406, the secure information that can be used to create a unique token for a transaction is generated. The secure information may be cryptographic keys or any other information such as an identifier. The secure information is then associated with the user information in a database in order to later verify that a token received for a user can be authenticated.

In step 408, the secure information is provided to a user. For example, if cryptographic keys are provided, they may delivered by any appropriate methods. For example, the cryptographic keys may be included in software that can generate a token and be shipped on media, downloaded, emailed, picked up in person, etc. Additionally, the cryptographic keys may be inherent in hardware, which can be shipped, picked up in person, etc.

Accordingly, embodiments of the present invention enable a user to generate a token and provide it to service requester 102. A token is generated using secure information that is not accessible to service requester 102. The token is then provided to service provider 106, which can then authenticate the token and provide the result to service requester 102.

Accordingly, redirection of the user to service provider 106 during the transaction is not necessary. Thus, this offers the advantage of avoiding the problems posed by redirection. Accordingly, a service requester 102 website does not have to be configured to support the redirection and a user does not need software and/or hardware to enable the redirection also. Additionally, a user does not have to submit secure information to a third party in order to have a token generated. Rather, the token is generated by the user using secure information associated with the user.

Accordingly, a token can be used in a three-party transaction, such as a credit card transaction, using embodiments of the present invention. This offers many advantages. For example, a third party can vouch for the user and thus accept liability for any fraud. However, redirection to the third party by a service requester is not necessary. Accordingly, three-party transactions can be performed without redirection.

While the present invention has been described using a particular combination of hardware and software implemented in the form of control logic, it should be recognized that other combinations of hardware and software are also within the scope of the present invention. The present invention may be implemented only in hardware, or only in software, or using combinations thereof. In one embodiment, the control logic may be in the form of instructions stored on an information storage medium, the instructions adapted to direct an information processing device to perform a set of steps.

The above description is illustrative but not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

1. A method for performing a three-party transaction with a user, service requester, and an authentication, the method comprising:
receiving a request for a secure transaction at the service requester;
receiving a token from the user, the token being generated by the user using secure information associated with the user;
providing the secure token to the authenticator, the authenticator capable of authenticating the token,
wherein the secure information is not accessible to the service requester.

2. The method of claim 1, further comprising receiving an authentication result from the authenticator indicating whether the token was authenticated or not.

3. The method of claim 2, further comprising processing the transaction based on the authentication result.

4. The method of claim 1, further comprising:
providing an input for the token, wherein the user manually enters the token in the input.

5. The method of claim 1, wherein the authenticator generates the secure information and provides the secure information to the user prior to receiving the request for the secure transaction.

6. The method of claim 5, wherein the secure information is stored in a token generator, the token generator configured to generate a unique token for the transaction.

7. The method of claim 1, wherein the token is unique for the transaction.

8. The method of claim 1, wherein the authenticator does not generate the token that is received.

9. The method of claim 1, wherein at least one of the first and second entities are on-line entities.

10. A method of authentication in a three-party transaction without using redirection, the method comprising:
receiving a request for authentication at a first entity;
requesting a token from a user;
receiving the token from the user, wherein the token is considered secure by the user and the user is not redirected to a second entity; and
authenticating the received token with the second entity.

11. The method of claim 10, wherein the second site provides secure information to the user prior to receiving the request, the secure information used to generate the token.

12. The method of claim 11, wherein the secure information is stored in a token generator, the token generator configured to generate a unique token for the transaction.

13. The method of claim 10, further comprising receiving an authentication result from the second entity indicating whether the token was authenticated or not.

14. The method of claim 13, further comprising processing the transaction based on the authentication result.

15. The method of claim 10, wherein the token is unique for the transaction.

16. The method of claim 10, wherein the second entity does not generate the token that is received.

17. The method of claim 10, wherein at least one of the first and second entities are on-line entities.

18. A system for authenticating a user, the system comprising:
a token generator configured to generate tokens;
a service requester configured to process a transaction for a user;
a service provider configured to authenticate tokens generated by the token generator,
wherein a user generates a unique token generated for the transaction using the token generator and provides the unique token to the service requester,
wherein the service requester cooperates with the service provider to authenticate the unique token.

19. The system of claim 18, wherein the service provider is configured to provide secure information to the user, wherein the secure information is accessible to the token generator and used to generate the unique token.

20. The system of claim 19, wherein the service requester comprises an on-line entity.

21. The system of claim 18, wherein the service provider comprises an on-line entity.
